(19) United States
(12) Patent Application Publication
(10) Pub. No.: US 2013/0107019 A1
(43) Pub. Date: May 2, 2013

(54) IMAGING DEVICE, IMAGE PROCESSING DEVICE AND IMAGE PROCESSING METHOD

(71) Applicant: FUJIFILM Corporation, Tokyo (JP)

(72) Inventors: Hiroyuki OOSHIMA, Saitama-shi (JP); Tomoyuki Kawai, Saitama-shi (JP)

(73) Assignee: FUJIFILM Corporation, Tokyo (JP)

(21) Appl. No.: 13/725,858

(22) Filed: Dec. 21, 2012

Related U.S. Application Data
(63) Continuation of application No. PCT/JP2011/061805, filed on May 24, 2011.

(30) Foreign Application Priority Data
Jun. 30, 2010 (JP) 2010-149789

(51) Int. Cl. H04N 13/02

(52) U.S. Cl. 348/49

(57) ABSTRACT

An imaging device, comprising: a single imaging optical system; an image pickup device; a stereoscopic image generating device configured to generate a stereoscopic image including the first planar image and a second planar image; a parallax amount calculating device configured to calculate a parallax amount in each part of the first planar image and the second planar image; a determination device configured to determine that a portion which has the parallax amount larger than a threshold value in the first planar image and the second planar image is a blurred portion; a blur processing device configured to perform blur processing on the blurred portion in the first planar image and the second planar image; and a high resolution planar image generating device configured to generate a high resolution planar image by combining the first planar image and the second planar image with each other after the blur processing.

This application is a continuation application and claims the priority benefit under 35 U.S.C. §120 of PCT Application No. PCT/JP2011/061805 filed on May 24, 2011 which application designates the U.S., and also claims the priority benefit under 35 U.S.C. §119 of Japanese Patent Application No. 2010-149789 filed on Jun. 30, 2010, which applications are all hereby incorporated in their entireties by reference.

### TECHNICAL FIELD

The present invention relates to an imaging device capable of generating a stereoscopic image comprising planar images of multiple viewpoints by using a single imaging optical system, and to an image processing device and an image processing method to perform image processing by using a planar image of multiple viewpoints obtained with the imaging device.

### BACKGROUND ART

Conventionally, imaging devices capable of generating a stereoscopic image comprising planar images of multiple viewpoints by using a single imaging optical system are known.

PTL 1 discloses a configuration which includes a single imaging optical system and generates a stereoscopic image by performing a pupil division by rotating a diaphragm.

PTL 2 discloses a configuration including a single imaging optical system, which divides the pupil with a microlens array and controls phase difference focusing.

PTL 3 discloses an imaging device including a single imaging optical system and an image pickup device in which a first pixel group and a second pixel group are disposed, each of which performs a photoelectric conversion on a luminous flux passing through different areas in the single imaging optical system to generate a stereoscopic image comprising a planar image obtained by the first pixel group and a planar image obtained by the second pixel group.

PTL 4 describes that, in the imaging device described in PTL 3, the output of a first pixel and the output of a second pixel are added to each other.

PTL 5 discloses a configuration in which an image is divided into plural areas and adds pixels only to a specific area that is low in intensity level or the like.

### CITATION LIST

### Patent Literature

{PTL 1} National Publication of International Patent Application No. 2009-527007
{PTL 2} Japanese Patent Application Laid-Open No. 4-267211
{PTL 3} Japanese Patent Application Laid-Open No. 10-42314
{PTL 4} Japanese Patent Application Laid-Open No. 2008-299184
{PTL 5} Japanese Patent Application Laid-Open No. 2007-251694

### SUMMARY OF INVENTION

### Technical Problem

In an imaging device capable of generating a stereoscopic image comprising planar images of multiple viewpoints by using a single imaging optical system (hereinafter, referred to as “monocular 3D imaging device”), when generating a high-resolution image from planar images of multiple viewpoints, a noise pattern is generated in an unfocused area within a high resolution planar image. A description is given below on the mechanism of generation of such noise pattern.

First, referring to FIG. 18A, a description is made on a case when three objects 9₁, 9₂ and 9₃ are taken by using a monocular imaging device which performs no pupil division. In the three images 9₁ₐ, 9₂ₐ, 9₃ₐ which are formed on an image pickup device 16, only the image 9₂ₐ of the object 9₂, which is located on a focus plane D, comes into focus on the image pickup device 16. Since the distance between the object 9₁ and an image taking lens 12 is larger than the distance between the object 9₁ and the focus plane D, and since a focus image 9_{1d} thereof is formed at a position closer to the image taking lens 12 than the image pickup device 16, an image 9₁, of the object 9₁ results in a blurred image. Since the distance between the object 9₃ and the image taking lens 12 is smaller than the distance between object 9₃ and the focus plane D, and since the focus image 9_{3d} is formed at a farther position from the image taking lens 12 than from the image pickup device 16, the image 9₃ₐ of the object 9₃ also results in a blurred image.

Subsequently, a description is made on a case when three objects 9₁, 9₂ and 9₃ are taken using a pupil division type monocular 3D imaging device. In the monocular 3D imaging device according to this example, there are two cases; i.e. a pupil of the image taking lens 12 is restricted only to position at an upper area by a shutter 9₅ as shown in FIG. 18B; and the pupil of the image taking lens 12 is restricted only to position at a lower area by a shutter 9₅ as shown in FIG. 18C. As described above, in the monocular 3D imaging device, the blur amount and position of the images formed on the image pickup device 16 are different from those in the monocular imaging device shown in FIG. 18A. That is, in the state shown in FIG. 18B, compared to the image 9₁ₐ of the object 9₁ in the case of no pupil division (FIG. 19A), in the image 9_{1b} of the object 9₁, the blur amount gets smaller and the position thereof shifts to the lower position in the figure as shown in FIG. 19B. Also, in the image 9_{3b} of the object 9₃, the blur amount gets smaller and the position thereof shifts to an upper area in the figure. In the state shown in FIG. 18C, compared to the image 9₁ₐ of the object 9₁ in the case of no pupil division (FIG. 19A), in the image 9_{1c} of the object 9₁, the blur amount gets smaller and the position thereof shifts to the upper position in the figure as shown in FIG. 19C. Also, in the image 9_{3c} of the object 9₃, the blur amount gets smaller and the position thereof shifts to a lower area in the figure.

In the monocular 3D imaging device as described above, when the image shown in FIG. 19B and the image shown in FIG. 19C are combined with each other to generate a high resolution planar image, since the image locations of the image 9_{1b}, the image 9_{1c}, image 9_{3b} and the image 9_{3c} are different from each other, a step-like noise pattern is caused. That is, there is a problem that a noise pattern caused from the parallax is generated within a blurred area in the high resolution planar image.

PTLs 1-5 do not disclose any configuration that assures both of high resolution in a high resolution planar image and elimination of noise pattern due to the parallax.

In the configuration described in PTL 4, since neighboring pixels are simply combined with each other, there is a problem that the resolution of a focused main object decreases due to the pixel addition. For example, in the case of combination of two pixels, the resolution decreases to ½. PTL 5 does not disclose a monocular 3D imaging device which is capable of generating stereoscopic image. Also, no description is given on a configuration which is capable of preventing the noise pattern caused from the parallax.

The present invention has been proposed in view of the above problem. An object of the present invention is to provide an imaging device, an image processing device and an image processing method capable of assuring the resolution in an area of a focused main object within a high resolution planar image formed by combining plural planar images including parallax as well as reliably eliminating noise pattern due to the parallax.

### Solution to Problem

In order to achieve the object, an aspect of the present invention provides an imaging device, which includes: a single imaging optical system; an image pickup device that has a first imaging pixel group and a second imaging pixel group each of which performs a photoelectric conversion on a luminous flux which has passed through a different area in the single imaging optical system; a stereoscopic image generating section that generates a stereoscopic image including a first planar image based on a pixel signal from the first imaging pixel group and a second planar image based on a pixel signal from the second imaging pixel group; a parallax amount calculating section that calculates a parallax amount in each part of the first planar image and the second planar image; a determination section that determines that a portion which has the parallax amount larger than a threshold value in the first planar image and the second planar image is a blurred portion; a blur processing section that performs blur processing on the blurred portion in the first planar image and the second planar image; and a high resolution planar image generating section that generates a high resolution planar image by combining the first planar image and the second planar image with each other after the blur processing. The number of pixels of the blurred “portion” is not limited. The determination of the blur and the blur processing may be made for each area or pixel.

That is, the blur processing is made on the portion where the parallax amount is larger than the threshold value in the first planar image and the second planar image. Accordingly, in the high resolution planar image which is formed by combining the first planar image and the second planar image including the parallax, the resolution is assured in a focused main object portion, and the noise pattern caused from the parallax is reliably eliminated.

Averaging of pixel value and filter processing are available as the blur processing. Another blur processing may be used.

According to another aspect of the present invention, the parallax amount calculating section calculates the parallax amount in each of the pixels of a first planar image and the second planar image, the determination section determines that a pixel which has the parallax amount larger than the threshold value is a blurred pixel, and the blur processing section picks up a pixel pair including a pixel in the first planar image and a pixel in the second planar image, each pixel pair corresponding to the first imaging pixel and the second imaging pixel which are disposed adjacent to each other in the image pickup device as a target, and performs the averaging of the pixel value between the pixels in the pixel pair including the blurred pixel.

Also, another aspect of the present invention provides an imaging device, which includes: a single imaging optical system; an image pickup device that has a first imaging pixel group and a second imaging pixel group each of which performs a photoelectric conversion on a luminous flux which has passed through a different area in the single imaging optical system; a stereoscopic image generating section that generates a stereoscopic image including a first planar image based on a pixel signal from the first imaging pixel group and a second planar image based on a pixel signal from the second imaging pixel group; a blur amount difference calculating section that calculates a difference of a blur amount between common portions in an imaging pixel geometry of the image pickup device, which is a difference of blur amount between each portion of the first planar image and each portion of the second planar image; a blur processing section that performs blur processing on a portion having an absolute value of the difference of blur amount larger than a threshold value in the first planar image and the second planar image; and a high resolution planar image generating section that generates a high resolution planar image by combining the first planar image and the second planar image with each other after the blur processing. The wording “common portions in the imaging pixel geometry” does not mean a completely identical portion since the imaging elements in the first planar image and in the second planar image are different from each other; but means an area overlapping with each other or pixels disposed adjacent to each other.

That is, the blur processing is made on an area where the difference of blur amount is larger than a threshold value. Accordingly, in the high resolution planar image which is formed by combining the first planar image and the second planar image including the parallax, the resolution is assured in a focused main object portion, and the noise pattern caused from the parallax is reliably eliminated.

According to another aspect of the present invention, the blur amount difference calculating section calculates a difference of sharpness between the pixels included in the pixel pair as the difference of blur amount.

According to another aspect of the present invention, the blur processing is averaging or filter processing of a pixel value in the portion with the absolute value of the difference of blur amount larger than the threshold value.

According to another aspect of the present invention, the blur amount difference calculating section takes, as a target, each pixel pair corresponding to the first imaging pixel and the second imaging pixel disposed adjacent to each other in the image pickup device, which is a pixel pair of a pixel of the first planar image and a pixel of the second planar image, and calculates the difference of blur amount between the pixels included in the pixel pair, and the blur processing section performs the averaging of the pixel value between the pixels in the pixel pair which has the absolute value of the difference of blur amount larger than the threshold value.

According to another aspect of the present invention, the blur amount difference calculating section takes, as a target, each pixel pair corresponding to the first imaging pixel and the second imaging pixel disposed adjacent to each other in the image pickup device, which is a pixel pair of a pixel of the first planar image and a pixel of the second planar image, and calculates the difference of blur amount between the pixels included in the pixel pair, and the blur processing section performs the filter processing on only the pixel with a smaller blur amount in the pixel pair which has the absolute value of the difference of blur amount larger than threshold value. That is, the filter processing is made only on the pixel where the blur amount is smaller in the pixel pair but the filter processing is not made on the pixel which has a larger blur amount in the pixel pair. Accordingly, the blur amount is prevented from expanding to the minimum while reliably eliminating the noise pattern caused from the parallax.

According to another aspect of the present invention, the blur processing section determines a filter coefficient based on at least the difference of blur amount.

According to another aspect of the present invention, the imaging device has a high resolution planar image imaging mode for generating the high resolution planar image, a low resolution planar image imaging mode for generating a low resolution planar image having the resolution lower than that of the high resolution planar image and a stereoscopic image imaging mode for generating the stereoscopic image, and when the high resolution planar image imaging mode is set, the high resolution planar image is generated.

According to another aspect of the present invention, the imaging device has a planar image imaging mode for generating the high resolution planar image and a stereoscopic image imaging mode for generating the stereoscopic image; and when the planar image imaging mode is set, the high resolution planar image is generated.

According to another aspect of the present invention, the pixel geometry of the image pickup device is a honeycomb arrangement.

According to another aspect of the present invention, the pixel geometry of the image pickup device is a Bayer arrangement.

Another aspect of the present invention provides an image processing device, which includes: a parallax amount calculating section that calculates a parallax amount of each portion of a first planar image based on a pixel signal from a first imaging pixel group and a second planar image based on a pixel signal of a second imaging pixel group, which is obtained by taking an image of an object using an image pickup device including the first imaging pixel group and the second imaging pixel group each of which performs a photoelectric conversion on a luminous flux which has passed through a different area of a single imaging optical system; a determination section that determines that a portion which has the parallax amount larger than a threshold value in the first planar image and the second planar image is a blurred portion; a blur processing section that performs blur processing on the blurred portion in the first planar image and the second planar image; and a high resolution planar image generating section that generates a high resolution planar image by combining the first planar image and the second planar image with each other after the blur processing.

Another aspect of the present invention provides an image processing device, which includes: a blur amount difference calculating section that calculates a difference of blur amount between common portions in imaging pixel geometry of an image pickup device, which is a difference of blur amount between the respective portions of a first planar image based on a pixel signal of a first imaging pixel group and a second planar image based on a pixel signal of a second imaging pixel group and which is obtained by taking an image of an object using an image pickup device including the first imaging pixel group and the second imaging pixel group each of which performs a photoelectric conversion on a luminous flux which has passed through different areas of a single imaging optical system; a blur processing section that performs blur processing on a portion which has an absolute value of the difference of blur amount larger than a threshold value in the first planar image and the second planar image; and a high resolution planar image generating section that generates a high resolution planar image by combining the first planar image and the second planar image with each other after the blur processing.

Also, another aspect of the present invention provides an image processing method, which includes: a step of generating, when an image of an object is taken using an image pickup device which has a first imaging pixel group and a second imaging pixel group each of which performs a photoelectric conversion on a luminous flux which has passed through different areas of a single imaging optical system, a high resolution planar image from a first planar image based on a pixel signal of the first imaging pixel group and a second planar image based on a pixel signal of the second imaging pixel group; a step of calculating the parallax amount of each portion of the first planar image and the second planar image; a step of determining that a portion which has the parallax amount larger than a threshold value in the first planar image and the second planar image is a blurred portion; a blur processing step of performing blur processing on the blurred portion in the first planar image and the second planar image; and a step of generating a high resolution planar image by combining the first planar image and the second planar image after the blur processing.

Moreover, another aspect of the present invention provides an image processing method, which includes: a step of generating, when an image of an object is taken using an image pickup device which has a first imaging pixel group and a second imaging pixel group each of which performs a photoelectric conversion on a luminous flux which has passed through different areas of a single imaging optical system, a high resolution planar image from a first planar image based on a pixel signal of the first imaging pixel group and a second planar image based on a pixel signal of the second imaging pixel group; a blur amount difference calculation step of calculating a difference of blur amount between common portions in an imaging pixel geometry of the image pickup device, which is a difference of blur amount between each portion of the first planar image and each portion of the second planar image; a blur processing step of performing blur processing on a portion which has the absolute value of the difference of blur amount larger than a threshold value in the first planar image and the second planar image; and a step of generating a high resolution planar image by combining the first planar image and the second planar image after the blur processing.

### ADVANTAGEOUS EFFECTS OF INVENTION

According to the present invention, the resolution is assured in the focused main object portion in a high resolution planar image which is formed by combining plural planar images including the parallax, and the noise pattern caused from the parallax is reliably eliminated.

### BRIEF DESCRIPTION OF DRAWINGS

FIG. 1 is a block diagram illustrating an example of a hardware configuration of an imaging device according to the present invention.

FIG. 2A illustrates an example of a configuration of an image pickup device.

FIG. 2B illustrates an example of a configuration of an image pickup device (main pixel).

FIG. 2C illustrates an example of a configuration of an image pickup device (sub pixel).

FIG. 3 illustrates an imaging pixel.

FIG. 4A is an enlarged illustration of an essential part in FIG. 3 (ordinary pixel).

FIG. 4B is an enlarged illustration of an essential part in FIG. 3 (phase difference pixel).

FIG. 5 is a block diagram of an essential part of an imaging device according to a first embodiment.

FIG. 6 is an illustration illustrating a RAW image, a left image, a right image and a parallax map.

FIG. 7 is a flowchart showing an example of an image processing flow according to the first embodiment.

FIG. 8 is a flowchart showing a processing flow of parallax map generation.

FIG. 9 is an illustration illustrating a relationship between the magnitude of parallax amount and the size of blur amount.

FIG. 10 is a block diagram of an essential part of an imaging device according to a second embodiment.

FIG. 11 is a flowchart showing an example of an image processing flow according to the second embodiment.

FIG. 12 illustrates an example of filter geometry of a Laplacian filter.

FIG. 13 is a block diagram of an essential part of an imaging device according to a third embodiment.

FIG. 14 is a graph showing a relationship between the difference |k| of the sharpness and a parameter a of a Gaussian filter.

FIG. 15 is a flowchart showing an example of an image processing flow according to the third embodiment.

FIG. 16 is a flowchart showing a flow of an imaging mode selection processing.

FIG. 17A schematically illustrates an example of a Bayer array.

FIG. 17B schematically illustrates another example of the Bayer array.

FIG. 18A is an illustration illustrating an essential part of an imaging system without pupil division.

FIG. 18B is an illustration illustrating an essential part of a monocular 3D imaging system with pupil division.

FIG. 18C is an illustration illustrating an essential part of a monocular 3D imaging system with pupil division.

FIG. 19A schematically illustrates a manner of imaging by an imaging system without pupil division.

FIG. 19B schematically illustrates a manner of imaging by a 3D monocular imaging system with pupil division.

FIG. 19B schematically illustrates a manner of imaging by a 3D monocular imaging system with pupil division.

### DESCRIPTION OF EMBODIMENTS

Embodiments of the present invention will be described below in detail referring to the appended figures.

<Entire Configuration of Imaging Device>

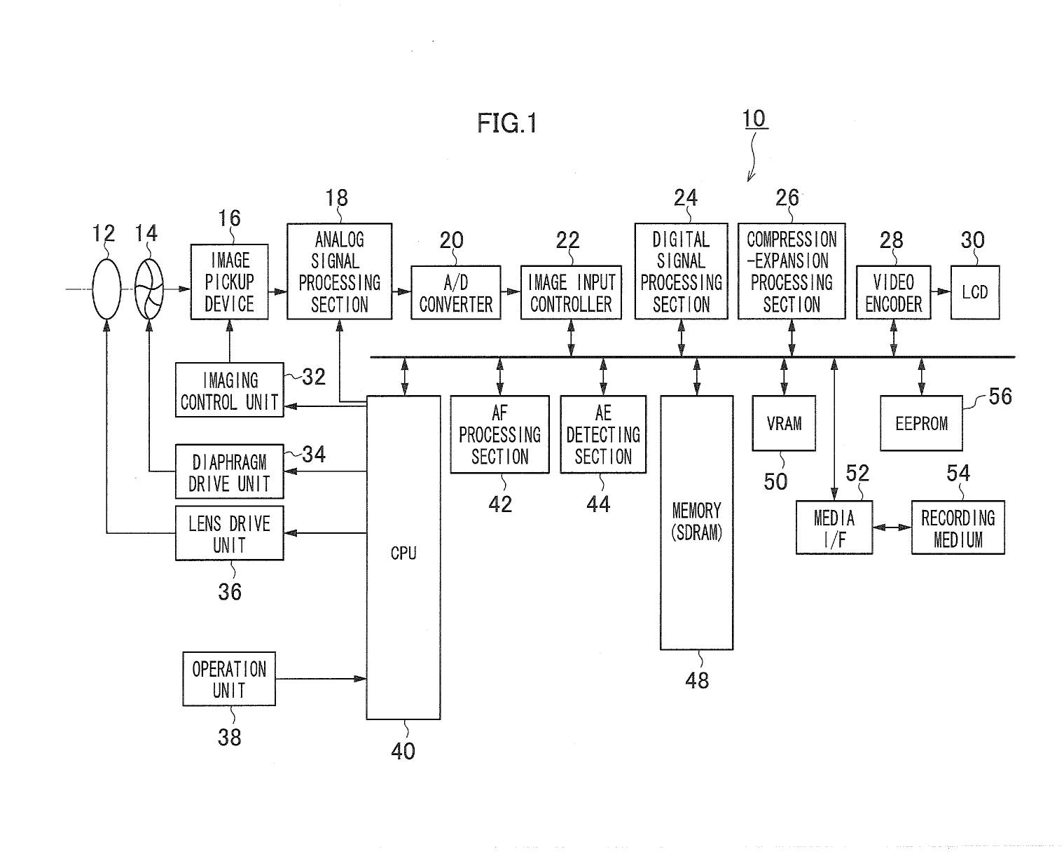

FIG. 1 is a block diagram illustrating a mode of implementation of an imaging device 10 according to an embodiment of the present invention.

The imaging device 10 takes an image and record the same on a recording medium 54. The entire operation of the apparatus is generally controlled by a central processing unit (CPU) 40.

The imaging device 10 has an operation unit 38 including a shutter button, a mode dial, a reproduction button, a MENU/OK key, an arrow key, a BACK key and the like. Signals output from the operation unit 38 are input into the CPU 40. The CPU 40 controls each circuit on the imaging device 10 based on the input signals. For example, the CPU 40 performs lens drive control, diaphragm drive control, imaging operation control, image processing control, recording/reproducing control of image data, display control of a liquid crystal display (LCD) 30 for 3D display and the like.

The shutter button is an operation button for inputting an instruction of imaging start. The shutter button includes a 2-step stroke type switch having an S1 switch that turns ON when the shutter button is pressed halfway, and an S2 switch that turns ON when the shutter button is fully pressed. The mode dial is an operation member for performing selection operation to select a 2D imaging mode, a 3D imaging mode, an auto imaging mode, a manual imaging mode, a scene position such as character, a scenery, a night scene, a macro mode, a video mode, and parallax-priority imaging mode relevant to the present invention.

The reproduction button is a button for switching the display mode to a reproducing mode to display a taken and recorded still or moving stereoscopic image (3D-image) or planar image (2D-image) on the liquid crystal display 30. The MENU/OK key is an operation key having the functions as a menu button which gives an instruction to display a menu on a screen of the liquid crystal display 30 and an OK button which gives an instruction to determine and execute a selected item. The arrow key is an operation section which functions as a button (operation member for cursor moving operation) to input an instruction of four directions of up/down, right/left for selecting an item from the menu screen to give an instruction to select various setting items from the menu. The UP/DOWN key of the arrow key functions as a zoom switch during imaging or a reproduction zoom switch during reproducing mode, and a LEFT/RIGHT key functions as a frame advance button (forward/reverse) in the reproducing mode. The BACK key is used to delete a desired item such as a selected item or an instruction, or to return to one previous operation mode.

In imaging mode, a beam of image light which represents an object fauns an image on an acceptance surface of an image pickup device 16, which is a solid-state image sensing device, through an image taking lens 12 (imaging optical system) including a focus lens and a zoom lens and a diaphragm 14. The image taking lens 12 is driven by a lens drive unit 36, which is controlled by the CPU 40, to perform a focus control, a zoom control and the like. The diaphragm 14 includes, for example, five diaphragm blades. The diaphragm 14 is driven by a diaphragm drive unit 34, which is controlled by the CPU 40, for example. The diaphragm 14 is controlled in 6-steps at 1 AV intervals in a range of aperture value of F1.4-F11.

Also, the CPU 40 controls the diaphragm 14 via the diaphragm drive unit 34, the charge accumulation time (shutter speed) by the image pickup device 16 via an imaging control unit 32, and image signal reading from the image pickup device 16.

<Example of Configuration of Monocular 3D Image Pickup Device>

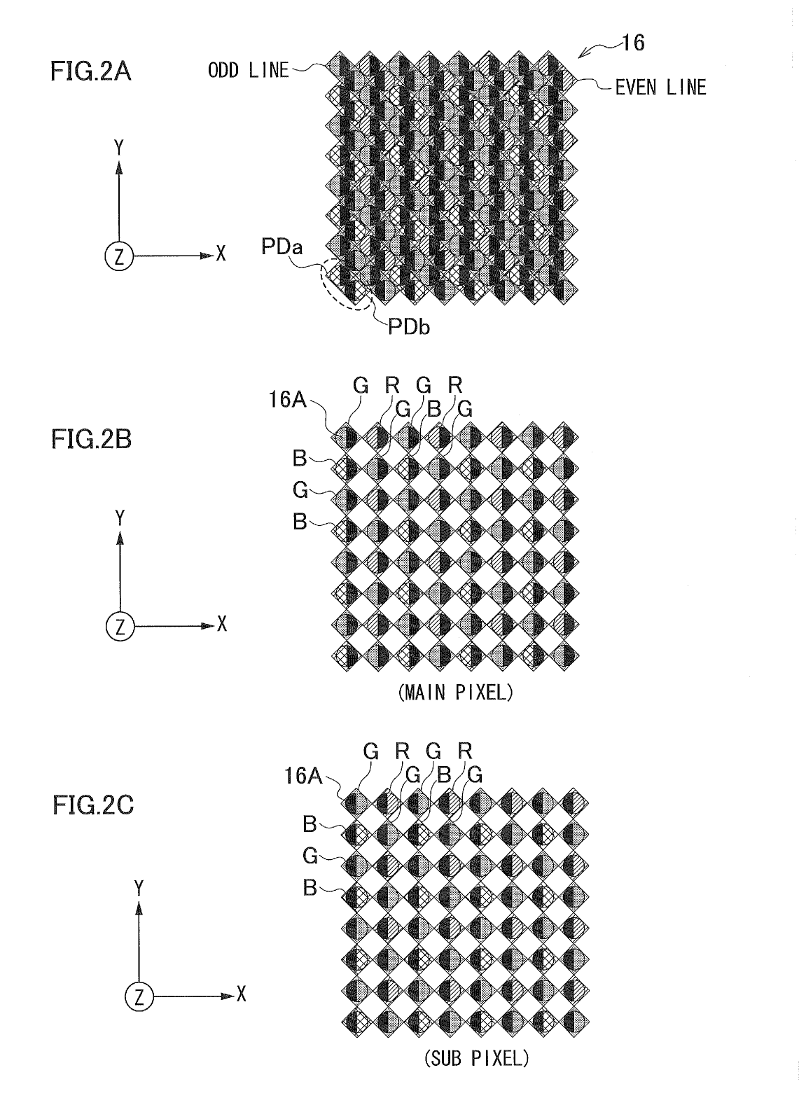

FIGS. 2A-2C each illustrate an example of configuration of the image pickup device 16.

The image pickup device 16 includes imaging pixels disposed in odd lines (hereinafter, referred to as “main pixel”) and imaging pixels disposed in even lines (hereinafter, referred to as “sub pixel”) in which the pixels are disposed in a matrix shape. Image signals form two planes, each of which is photoelectrically converted by the main pixels and sub pixels can be read separately.

In the odd lines (1, 3, 5, . . . ) of the image pickup device 16, in the pixels having color filters of R (red), G (green) and B (blue), lines disposed with pixels of GRGR . . . and lines disposed with pixels of BGBG . . . are formed alternately as shown in FIG. 2B. While, in the pixels in even lines (2, 4, 6, . . . ), lines disposed with pixels of GRGR . . . and lines disposed with pixels of BGBG . . . are formed alternately same as the odd lines, and each of the pixels is disposed being displaced by a half pitch of a disposition pitch in a line direction with respect to the pixels of the even lines as shown in FIG. 2C. That is, the pixels on the image pickup device 16 are disposed in honeycomb geometry.

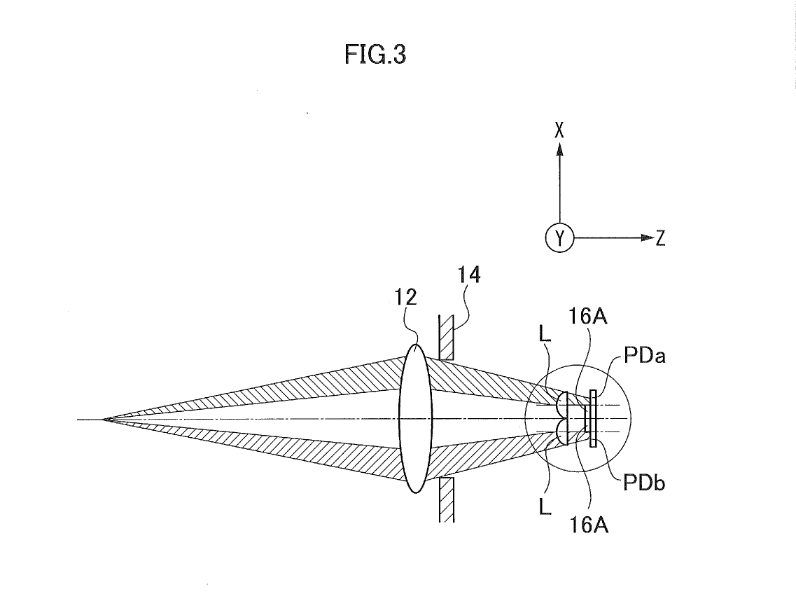

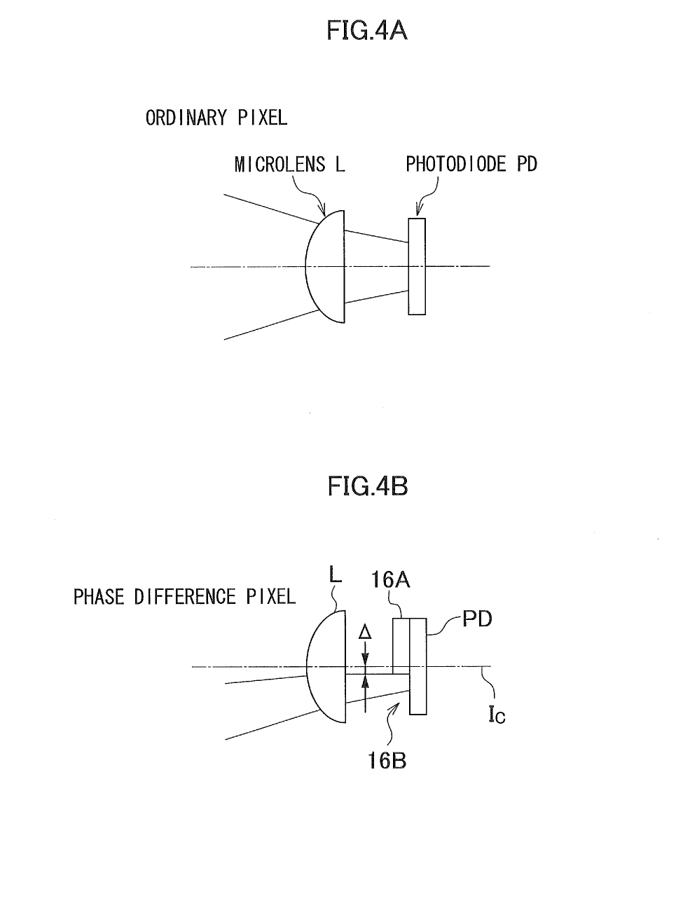

FIG. 3 illustrates one pixel that includes an image taking lens 12, a diaphragm 14, and a main pixel PDa and a sub pixel PDb on the image pickup device 16. FIG. 4A and FIG. 4B each illustrate an essential part in FIG. 3.

A luminous flux passing through an exit pupil enters into a pixel (photodiode PD) of an ordinary image pickup device via a microlens L without being subjected to any restriction as shown in FIG. 4A. Contrarily, on the main pixel PDa and sub pixel PDb of the image pickup device 16, a light shielding member 16A is formed, and the right-half or left-half of the acceptance surface on the main pixel PDa and the sub pixel PDb is light-shielded by the light shielding member 16A. That is, the light shielding member 16A has a function as a pupil division member.

In the configuration of the image pickup device 16, the main pixel PDa and the sub pixel PDb are configured so that the area where the luminous flux is restricted by the light shielding member 16A (right-half, left-half) is different from each other; but the present invention is not limited to the above. For example, the microlens L and the photodiode PD (PDa, PDb) may be relatively displaced in a horizontal direction without forming the light shielding member 16A to thereby restrict the luminous flux incoming into the photodiode PD; or one microlens may be provided to two pixels (main pixel and sub pixel) to thereby restrict the luminous flux coming into the pixels.

Returning to FIG. 1, the signal charge accumulated on the image pickup device 16 is read as a voltage signal corresponding to the signal charge based on the read signal applied by the imaging control unit 32. The voltage signal read from the image pickup device 16 is applied to the analog signal processing section 18, and here, R, G and B signals of each pixel are held as sampling and amplified to a gain (equivalent to ISO sensitivity) specified by the CPU 40 to be applied to an AID converter 20. The A/D converter 20 converts sequentially input R, G and B signals into digital R, G and B signals and outputs the same to an image input controller 22.

The digital signal processing section 24 performs predetermined signal processing on the digital image signals which are input via the image input controller 22 such as an offset processing, a white balance correction, a gain/control processing including sensitivity correction, gamma correction processing, a synchronizing processing (color interpolation processing), a YC processing, a contrast emphasizing processing and an outline correction processing.

An EEPROM (electrically erasable programmable read-only memory) 56 is a non-volatile memory which stores various parameters, tables and program diagrams used for a camera control program, information on defect of image pickup device 16, image processing and the like.

As shown in FIG. 2B and FIG. 2C, main image data which is read from the main pixels in the odd lines on the image pickup device 16 are processed as a planar image for left-view (hereinafter, referred to as “left image”); while sub image data which is read from the sub pixels in the even lines are processed as a planar image for right-view (hereinafter, referred to as “right image”).

The left image and the right image each processed by the digital signal processing section 24 are input into a VRAM (video random access memory) 50. The VRAM 50 includes A-area and B-area each of which stores 3D-image data representing a three dimensional (3D) image for one frame. In the VRAM 50, 3D-image data representing a 3D-image for one frame is alternately re-written on the A-area and the B-area. In the A-area and the B-area in the VRAM 50, a piece of written 3D-image data is read from an area other than the area where the 3D-image data is re-written. The 3D-image data read from the VRAM 50 is encoded by a video encoder 28 and output to the liquid crystal display 30 for 3D display provided at the rear side of a camera. With this, an image of the 3D object is displayed on the display screen of the liquid crystal display 30.

The liquid crystal display 30 is a 3D display device capable of displaying the stereoscopic image (left image and right image) as a directional image each having a predetermined directive property with a parallax barrier. The 3D display device is not limited to the above. For example, such 3D display device, in which a lenticular lens is used or user wears dedicated glasses such as polarization glasses or liquid crystal shutter glasses to thereby separately recognize the left image and right image, may be employed.

When a shutter button on the operation unit 38 is pressed down to a first step (press shutter button halfway), the image pickup device 16 starts an AF (automatic focus adjustment) operation and an AE (automatic exposure) operation, and controls the focus lens in the image taking lens 12 to position at a focusing position via the lens drive unit 36. When a shutter button on the operation unit 38 is pressed down to halfway, the image data output from the A/D converter 20 is received by an AE detecting section 44.

The AE detecting section 44 integrates G-signals of the entire screen or G-signals which are subjected to weighting different in the central area and peripheral area of the screen, and outputs the integrated value to the CPU 40. The CPU 40 calculates the brightness (imaging EV value) of an object based on the integrated value input from the AE detecting section 44, and determines an aperture value of the diaphragm 14 and the electronic shutter (shutter speed) of the image pickup device 16 based on the imaging EV value in accordance with a predetermined program diagram. The CPU 40 controls the diaphragm 14 via the diaphragm drive unit 34 based on the determined aperture value, and controls the charge accumulation time on the image pickup device 16 via the imaging control unit 32 based on a determined shutter speed.

An AF processing section 42 performs a contrast AF processing or a phase AF processing. When performing the contrast AF processing, the AF processing section 42 extracts high-frequency components of the image data within a predetermined focus area at least in one image data of the left image data and the right image data, and calculates an AF evaluation value representing a focusing state by integrating the high-frequency components. The AF is controlled by controlling the focus lens within the image taking lens 12 so that the AF evaluation value is the maximum. When performing the phase AF processing, the AF processing section 42 detects a phase difference in the image data corresponding to the main pixels and the sub pixels within a predetermined focus area in the left image data and the right image data, and calculates defocus amount based on the information representing the phase difference. The AF control is made by controlling the focus lens within the image taking lens 12 so that the defocus amount is 0.

When the AE operation and the AF operation have completed and when the shutter button is pressed down in two-steps (full press-down), responding to this press-down, a piece of image data for two images; i.e. the left image and the right image corresponding to the main pixel and the sub pixel output from the A/D converter 20 is input to a memory (SDRAM: Synchronous Dynamic Random Access Memory) 48 from the image input controller 22 and temporarily stored therein.

The image data for two images, which is temporarily stored in the memory 48, is appropriately read out by the digital signal processing section 24 and is subjected to a predetermined signal processing including brightness data and color difference data generation processing (YC processing) of the image data. The YC processed image data (YC data) is stored in the memory 48 again. Subsequently, the YC data for two images is output to a compression-expansion processing section 26 respectively, and after being subjected to a predetermined compression processing such as JPEG (joint photographic experts group), the data is stored in the memory 48 again.

A multi picture file (MP file: a file in which plural images are combined with each other) is generated from the YC data for two images stored in the memory 48 (compressed data). The MP file is read out via a media interface (media I/F) 52 and recorded in a recording medium 54.

Description will be made below on several embodiments of the imaging device according to the present invention.

### First Embodiment

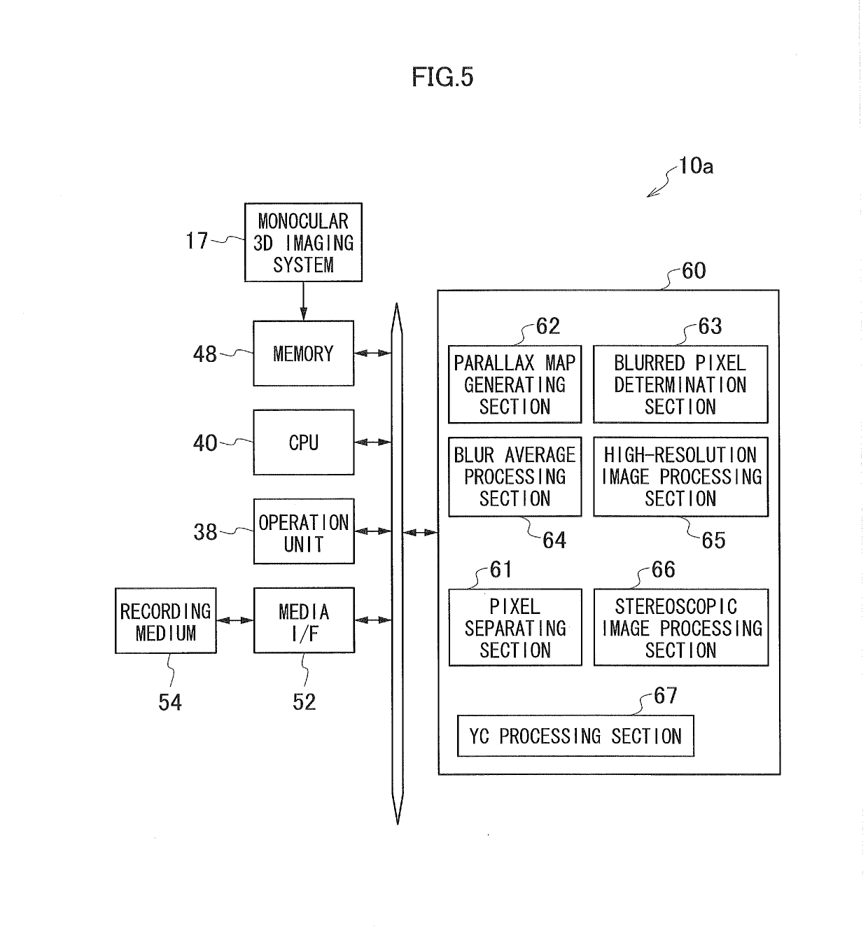

FIG. 5 is a block diagram of an essential part of an imaging device 10a according to a first embodiment. In FIG. 5, the same elements as those shown in FIG. 1 are given with the same reference numeral and character respectively, and as for the items which have been described above, description thereof is omitted here.

The monocular 3D imaging system 17 according to the first embodiment includes, in particular, an image taking lens 12, a diaphragm 14, an image pickup device 16, an analog signal processing section 18 and an A/D converter 20 which are shown in FIG. 1. That is, the monocular 3D imaging system 17 includes the single image taking lens 12 (imaging optical system) and the image pickup device 16 that has a main pixel group and a sub pixel group each of which performs a photoelectric conversion on a luminous flux which has passed through a different area in the single image taking lens 12.

The monocular 3D imaging system 17 takes an image of an object and generates a RAW image which is formed by pixel signals output from the main pixel (first imaging pixel) group shown in FIG. 2B and pixel signals output from the sub pixel (second imaging pixel) group shown in FIG. 2C. The geometry of pixels (referred to as “image pixel”) in the RAW image corresponds to the geometry of the imaging pixels (photodiode PD) shown in FIG. 2A.

A DSP (Digital Signal Processor) 60 includes a digital signal processing section 24 shown in FIG. 1. In FIG. 5, the CPU 40 and the DSP 60 are shown as a separate element respectively; but they may be configured integrally. Also, a part of the components of the DSP 60 may include the CPU 40.

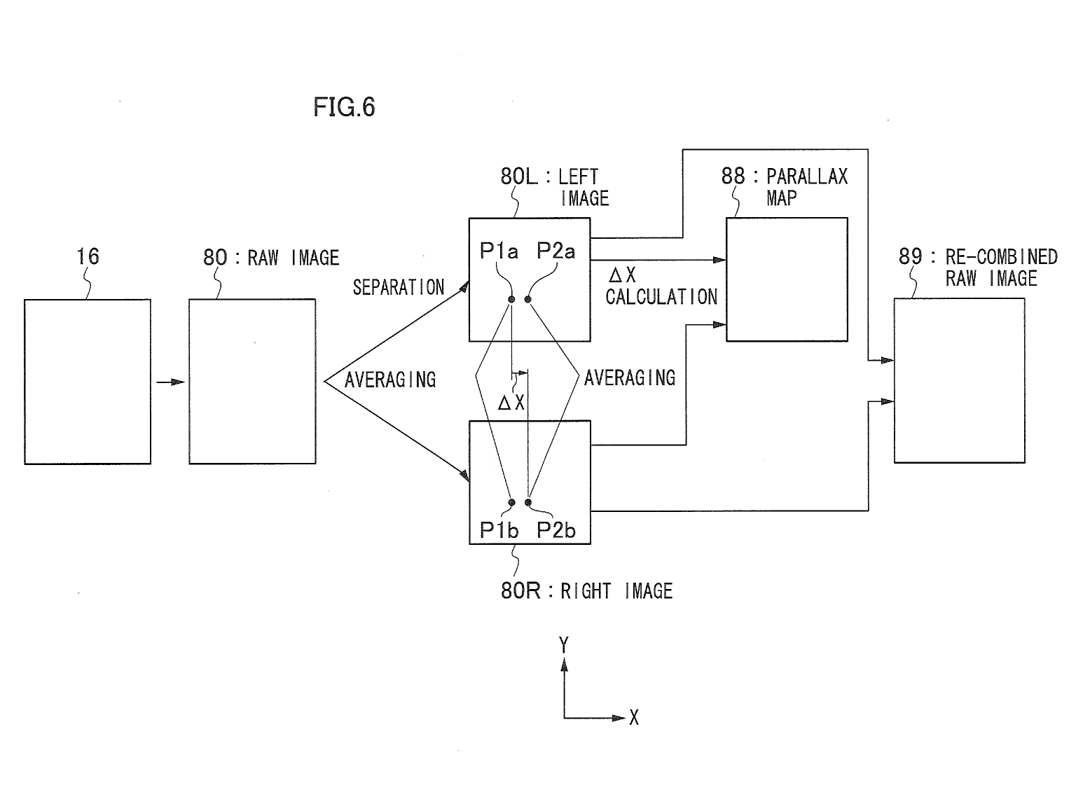

A pixel separating section 61 separates a RAW image 80, in which pixels shown in FIG. 2A correspond to the position into a left image 80L (first planar image) which corresponds to the pixel geometry of the main pixel group shown in FIG. 2B and a right image 80R (second planar image) which corresponds to the pixel geometry of the sub pixel group shown in FIG. 2C as shown in FIG. 6.

A parallax map generating section 62 detects a correspondence relationship of two pixels representing an identical point of an identical object between the left image 80L and the right image 80R, calculates a parallax amount ΔX between the pixels having the correspondence relationship to generate a parallax map 88 that represents the correspondence relationship between the pixels and the parallax amount ΔX as shown in FIG. 6. In other words, the parallax map generating section 62 calculates the parallax amount in each portion of the left image 80L and the right image 80R.

For example, the difference ΔX of the coordinate value in the x-direction between a pixel P1a of the left image 80L and a pixel P2b of the right image 80R in FIG. 6 is calculated as the parallax amount. The first parallax map 88 according to the first embodiment corresponds to the pixel geometry of the left image 80L and represents the parallax amount of each pixel in the left image 80L.

A blurred pixel determination section 63 compares a threshold value and the parallax amount (absolute value) of each of the pixels in the left image 80L and the right image 80R based on the parallax map 88 generated by the parallax map generating section 62, and determines that a pixel having the parallax amount (absolute value) larger than the threshold value is a blurred pixel. That is, the blurred pixel determination section 63 determines whether or not at least either one of the pixels blurs in each pixel pair, which is a pixel pair including a pixel of the left image 80L and a pixel of the right image 80R, which corresponds to a main pixel and a sub pixel positioned adjacent to each other in the image pickup device 16. For example, in FIG. 6, the pixel P1a of the left image SOL and the pixel P1b of the right image 80R form a pixel pair; and a pixel P2a of the left image 80L and a pixel P2b of the right image 80R form a pixel pair. In other words, the blurred pixel determination section 63 determines that, in the left image 80L and the right image 80R, a portion where the parallax amount is larger than the threshold value is a blurred portion.

A blur average processing section 64, taking each pixel pair corresponding to the main pixel and the sub pixel, which are positioned adjacent to each other in the image pickup device 16 as a target, performs a blur processing to make the blur amount equal between the pixels included in the pixel pair on a pixel pair which includes the blurred pixel; while does not perform the blur processing on a pixel pair which does not include any blurred pixel. For example, in FIG. 6, the averaging of the pixel value is made between the pixel P1a of the left image 80L and the pixel P1b of the right image 80R; while the averaging of the pixel value is made between the pixel P2a of the left image 80L and the pixel P2b of the right image 80R. In other words, the blur average processing section 64 performs the blur processing on a blurred portion in the left image 80L and the right image 80R.

A high-resolution image processing section 65 combines the left image 80L and the right image 80R with each other, which has been subjected to the averaging processing by the blur average processing section 64, to generate a high resolution planar image (hereinafter, “high resolution planar image”) as a recombined RAW image. Here, the high resolution planar image is a piece of planar image data which corresponds to the pixel geometry of all pixels on the image pickup device 16 shown in FIG. 2A. According to the first embodiment, the high resolution planar image has a resolution two times of the resolution of the left image (or right image).

The stereoscopic image processing section 66 performs image processing on a stereoscopic image including the left image 80L and the right image 80R which are not subjected to the averaging processing by the blur average processing section 64. The left image 80L is a piece of planar image data corresponding to the pixel geometry of the main pixel PDa shown in FIG. 2B; while the right image 80R is a piece of planar image data corresponding to the pixel geometry of the sub pixel PDb shown in FIG. 2C.

An YC processing section 67 converts an image having R, G and B pixel signals into an image of Y and C image signals.

A 2D image generating apparatus that generates a 2D-image (high resolution planar image, 2D low-resolution image) having R, G and B pixel signals includes the pixel separating section 61, the parallax map generating section 62, the blurred pixel determination section 63, the blur average processing section 64 and the high-resolution image processing section 65 shown in FIG. 5. A 3D image generating apparatus that generates a stereoscopic image having R, G, B pixel signals includes the pixel separating section 61 and the stereoscopic image processing section 66 shown in FIG. 5.

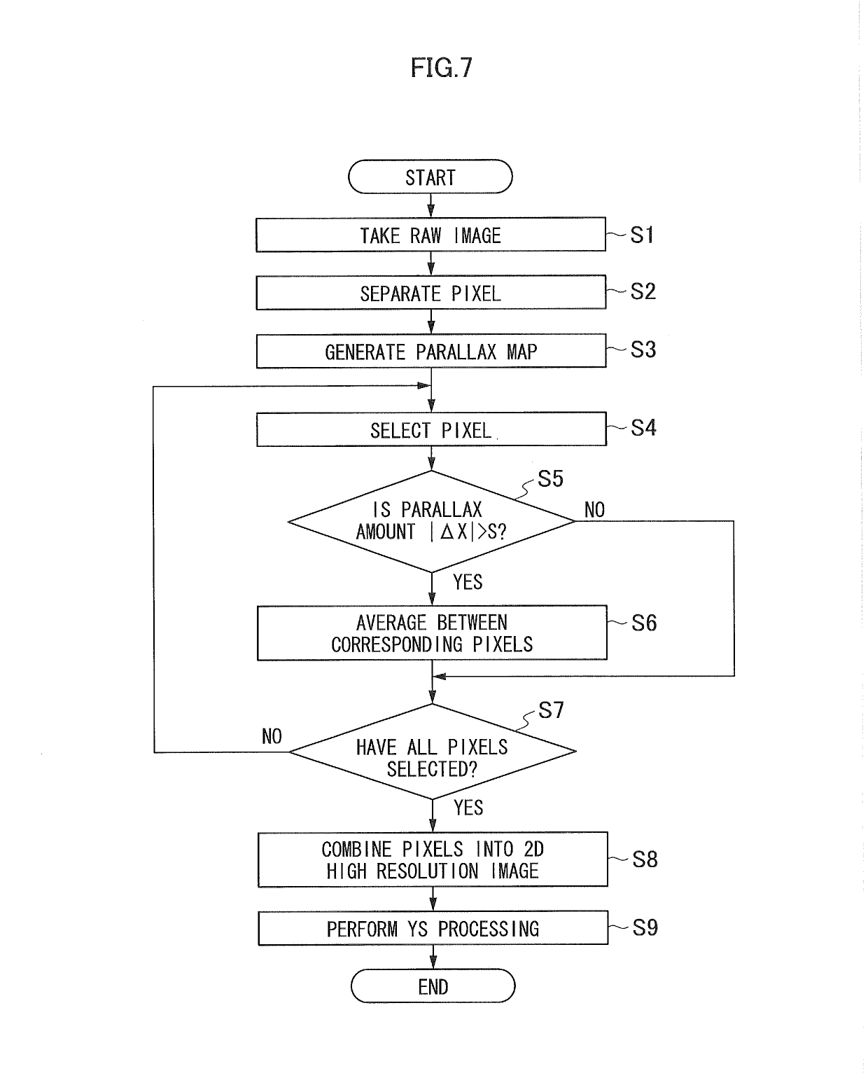

FIG. 7 is a flowchart showing an image processing flow according to the first embodiment. The processing is executed under the control by the CPU 40 in accordance with a program.

First of all, the monocular 3D imaging system 17 takes an image of an object to obtain a RAW image 80 in step S1. That is, the RAW image 80 which includes the pixel signals output from all pixels on the image pickup device 16 shown in FIG. 2A is stored in the memory 48.

Subsequently, the pixel separating section 61 separates the RAW image 80 into a left image 80L and a right image 80R in step S2.

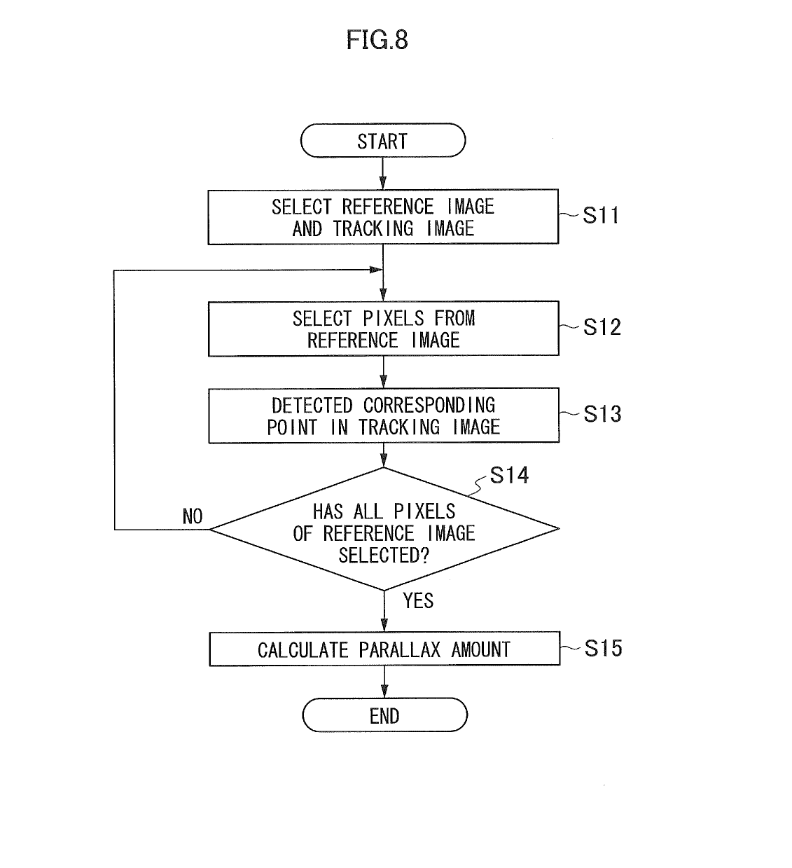

Subsequently, the parallax map generating section 62 generates a parallax map 88 in step S3. FIG. 8 is a flowchart illustrating the step S3 in detail. Either one of the left image 80L and the right image 80R is selected (in this embodiment, the left image 80L) as a reference image; the other image (in this embodiment, right image 80R) is determined as a tracking image (step S11). Subsequently, target pixels are selected in order from the reference image 80L (step S12). Subsequently, from the tracking image 80R, a pixel which has the same characteristics as those of the target pixel in the reference image 80L is detected, and a correspondence relationship between the target pixel of the reference image 80L and the detected pixel of the tracking image 80R is stored in the memory 48 (step S13). It is determined if the selection of all pixels of the reference image 80L has completed (step S 14); if not, the process returns to step S12, and if yes, a calculation of the parallax amount ΔX is made to create the parallax map 88(step S15). That is, the parallax map 88 which represents the correspondence relationship between each pixel of the left image 80L and the parallax amount ΔX is generated.

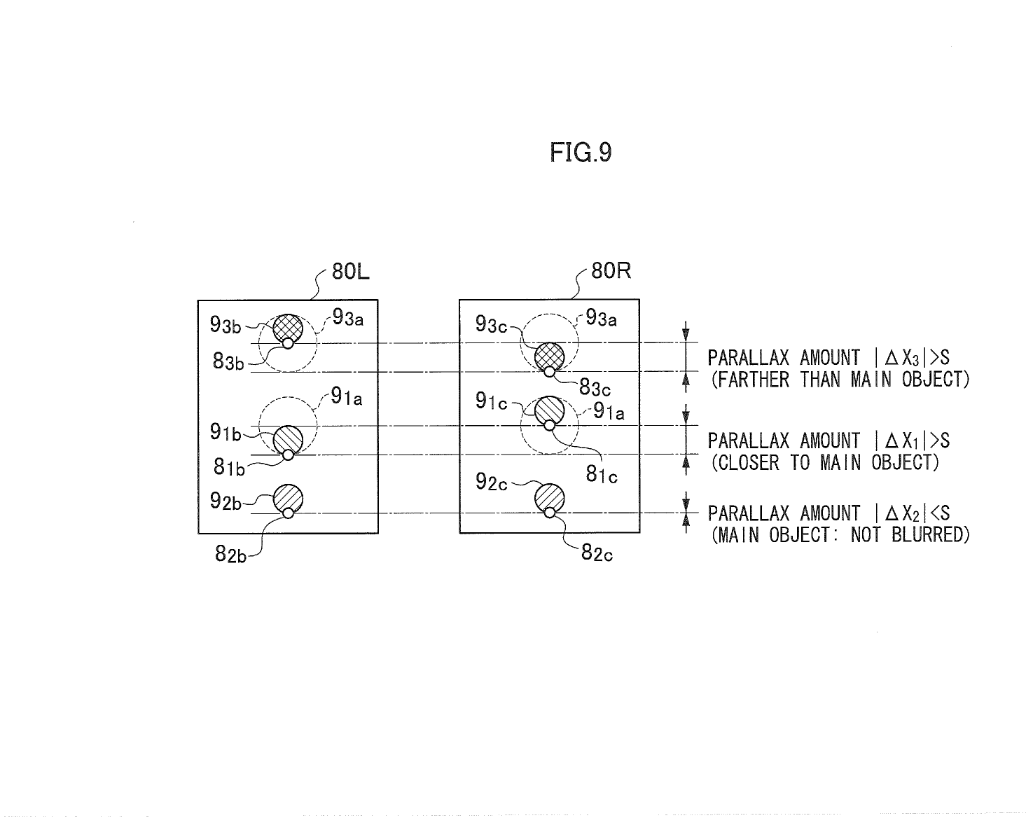

Here, a description is made on a relationship between the parallax amount ΔX and noises generated on the RAW image 80. As shown in FIG. 9, the parallax amount is a positional difference ΔX on the coordinate (for example, ΔX₁, ΔX₂ and ΔX₃) between the pixels in the left image 80L (for example, 81b, 82b and 83b) and the corresponding pixels in the right image 80R (for example, 81e, 82c and 83c) the characteristics of which is the same as those of the pixels in the left image 80L. When the calculated parallax amount ΔX is large, between the main pixel PDa and the sub pixel PDb disposed as a pair on the image pickup device 16 shown in FIG. 2A, the position on the acceptance surface of the image pickup device 16 is substantially the same (adjacent to each other), but the amount of received light (amount of entered light) is largely different. That is, in the RAW image 80, in an area having a large parallax amount ΔX, a step-like noise may be generated. If the RAW image 80 which includes such noises is processed as a high resolution planar image and if any image processing such as contrast emphasizing and/or outline correction is made, the noises appear noticeably. Therefore, in the following steps S4-S7, image processing is made to eliminate the noises while maintaining the high resolution.

A target pixel is selected from the reference images (for example, left image 80L) in step S4.

In step S5, the blurred pixel determination section 63 determines if the absolute value |ΔX| of the parallax amount of the target pixel is larger than the threshold value S based on the parallax map 88 corresponding to the reference image 80L. A target pixel which has the |ΔX| larger than the threshold value S is determined to be a blurred pixel. For example, the pixels 8_{1b} and 8_{3b} in the left image 80L shown in FIG. 9 are determined as blurred pixels the |ΔX| of which is larger than the threshold value S. Likewise, the pixels 8_{1c}, and 8_{3c} in the right image 80R are determined as blurred pixels. On the other hand, the pixel 8_{2b}, and 8_{2c} which have the |ΔX| smaller than the threshold value S are determined as pixels which are not blurred. Between the |ΔX| and the noise amount, there is a relationship that the larger |ΔX| proportionally results in the larger noise amount. The correspondence relationship between the |ΔX| and the noise amount is obtained from an experience and/or calculation, and based on the correspondence relationship, the threshold value S is previously obtained and preset in the EEPROM 56 or the like. The value of the threshold value S is not particularly limited, but the value should be smaller enough than the stereoscopic fusion limit of human eyes (1/n or less of stereoscopic fusion limit).

When the pixel is determined as blurred pixel, in step S6, the blur average processing section 64 performs averaging between the pixel value of the blurred pixel in the reference image 80L and the pixel value of the pixel in the other planar image 80R which is disposed as a pair of the blurred pixels in the pixel geometry of the image pickup device 16. That is, the blur processing is made to equalize the blur amount between the pixels included in a pixel pair (blur equalization processing).

As shown in FIG. 2A, since the main pixel PDa and the sub pixel PDb are disposed as a pair on the image pickup device 16, the pixel value is averaged between the pixel corresponding to the PDa in the left image 80L and the pixel corresponding to the PDb in the right image 80R. The main pixel PDa and sub pixel PDb according to the first embodiment are the imaging pixels of the same color which are disposed being adjacent to each other on the image pickup device 16. The averaged value between the pixel values of the two imaging pixels is set to the pixel of the left image 80L and the pixel of the right image 80R.

In step S7, it is determined if the selection of all pixels has completed. If not, the process returns to step S4; and if yes, the process proceeds to step S8.

In step S8, the high-resolution image processing section 65 combines the left image 80L and the right image 80R with each other to generate a high resolution planar image.

In step S9, the YC processing section 67 performs YC processing to convert the high-resolution image which includes R, G and B pixel signals into a high-resolution image including a Y (brightness) signal and a C (color difference) signal.

According to the first embodiment, in the entire area of the high resolution planar image, only the portion that has a larger blur amount is limited as the target area of the averaging. Therefore, noises are reduced without reducing the resolution of the focused main object.

The number of pixels in the blurred “portion” is not limited. The determination of blur and the blur processing may be performed on each area or pixel. As the blur processing, only the averaging between the pixel values has been described above. However, the blur processing may be made by using a filter processing (for example, Gaussian filter) which will be described below.

### Second Embodiment

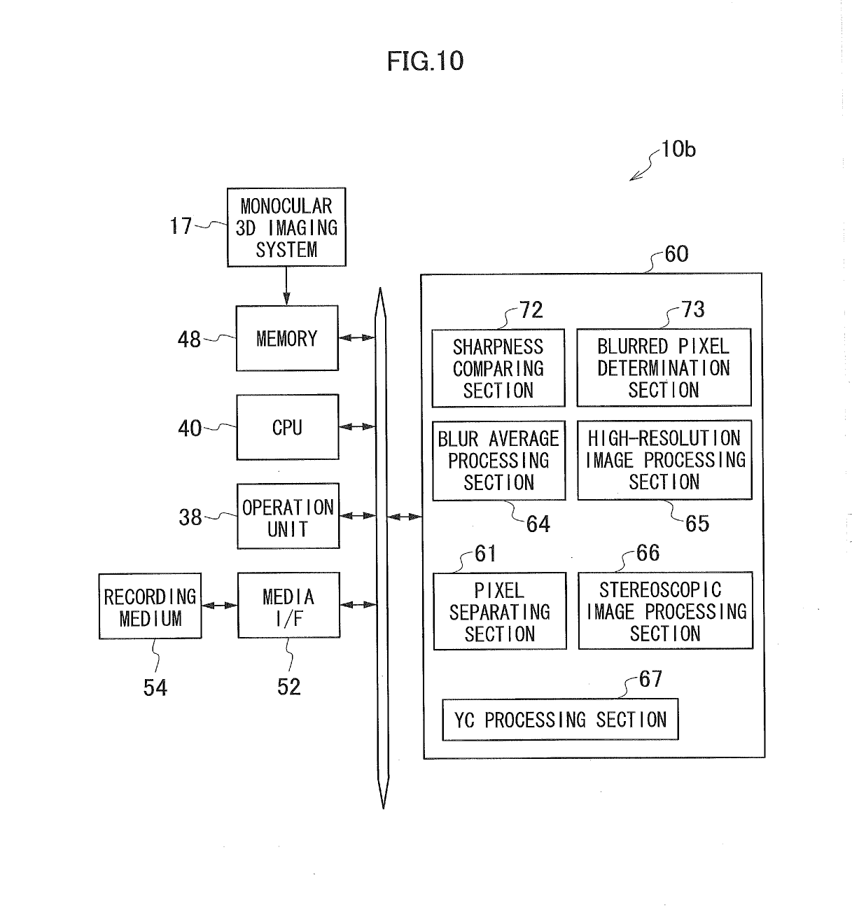

FIG. 10 is a block diagram illustrating an essential part of an imaging device 10b according to a second embodiment. The same components as those in the imaging device 10a according to the first embodiment shown in FIG. 5 are given with the same reference numerals and symbols; and as for the items which have been described in the first embodiment, the description thereof will be omitted.

A sharpness comparing section 72 (blur amount difference calculating section) compares the sharpness between a pixel in the left image and a pixel in the right image corresponding to the main pixel PDa and the sub pixel PDb which are disposed adjacent to each other in the image pickup device 16, and calculates a sharpness difference therebetween.

The sharpness difference between the pixels represents a difference of the blur amount between the pixels. The larger sharpness difference means the larger difference of the blur amount between the pixels. That is, the sharpness comparing section 72 takes, as a target, each pixel pair corresponding to the main pixel PDa and the sub pixel PDb disposed adjacent to each other in the image pickup device 16; the pixel pair includes a pixel of the left image and a pixel of the right image. The sharpness comparing section 72 calculates the sharpness difference between pixels included in the pixel pair, which represents a difference of blur amount therebetween. In other words, the sharpness comparing section 72 calculates a difference of the blur amount between the portions having the same imaging pixel geometry in the image pickup device 16; which is a difference of the blur amount between each portion in the left image 80L and each portion in the right image 80R. The imaging elements in the first planar image and the imaging elements in the second planar image are different from each other. Therefore, the wording “portions having the same imaging pixel geometry” does not mean the portions that are completely identical to each other; but the wording represents the areas that overlap with each other, or, pixels that are disposed adjacent to each other.

The blurred pixel determination section 73 according to the second embodiment compares an absolute value of the sharpness difference (a difference of blur amount) calculated by the sharpness comparing section 72 to a threshold value. The blurred pixel determination section 73 determines to perform the averaging between the pixels included in the pixel pair on a pixel pair which has the absolute value of the sharpness difference larger than the threshold value. On the other hand, the blurred pixel determination section 73 determines, not to perform the averaging processing on a pixel pair which has the absolute value of the sharpness difference smaller than the threshold value. In other words, the blurred pixel determination section 73 determines to perform the blur processing on a portion having the absolute value of the blur amount difference larger than the threshold value in the left image 80L and the right image 80R.

The blur average processing section 64 performs averaging of the pixel values between the pixels included in the pixel pair based on the determination result by the blurred pixel determination section 73. That is, the blur average processing section 64 takes each pixel in the left image and the right image as a target. When the absolute value of the sharpness difference is larger than a threshold value, the pixels each corresponding to the main pixel PDa and the sub pixel PDb disposed adjacent to each other in the image pickup device 16 are subjected to the averaging. On the other hand, when the absolute value of the sharpness difference is smaller than the threshold value, the blur average processing section 64 does not perform the averaging. That is, the blur average processing section 64 performs the blur processing on the portion having the absolute value of the blur amount difference larger than the threshold value.

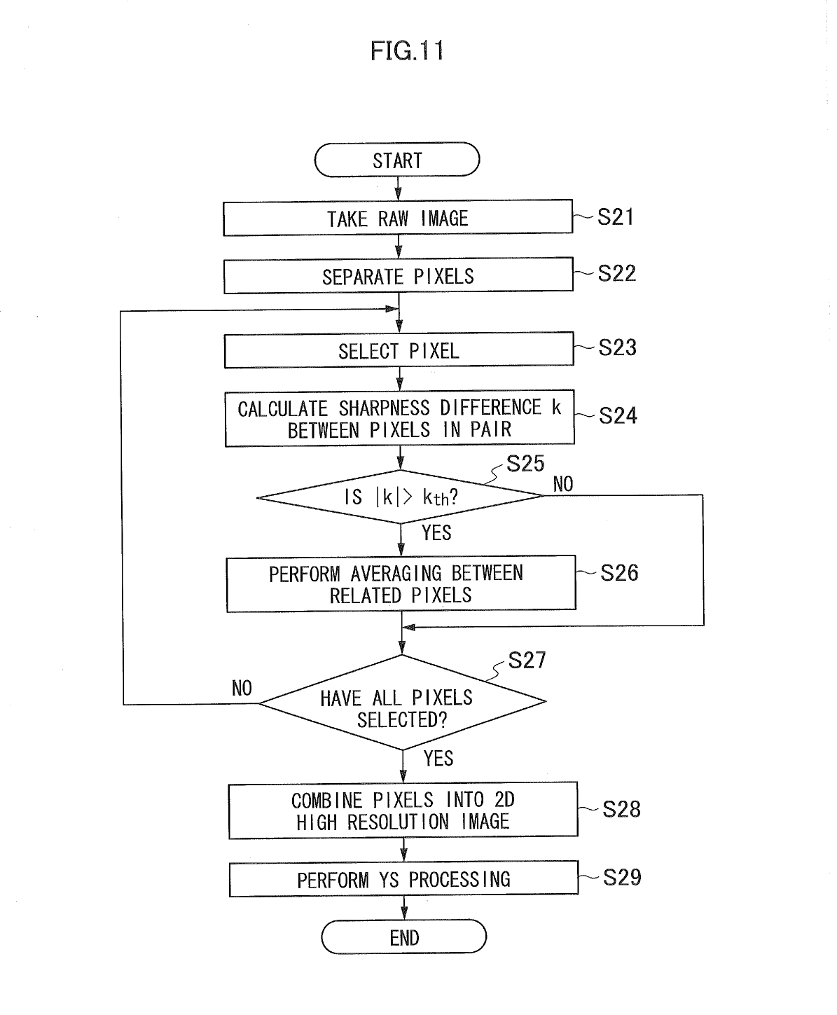

FIG. 11 is a flowchart showing an example of an image processing flow according to the second embodiment.

Steps S21 and S22 are the same as the steps S1 and S2 in the first embodiment shown in FIG. 7.

In step S23, a target pixel is selected from reference images (for example, left image 80L).

In step S24, the sharpness comparing section 72 calculates the sharpness difference between the pixels of the left image 80L and the right image 80R which are disposed as a pair in the pixel geometry of the image pickup device 16. For example, the sharpnesses Sa and Sb of the pixels in the left image 80L and the right image 80R are calculated, and the difference of the sharpness therebetween (k=Sa−Sb) is calculated.

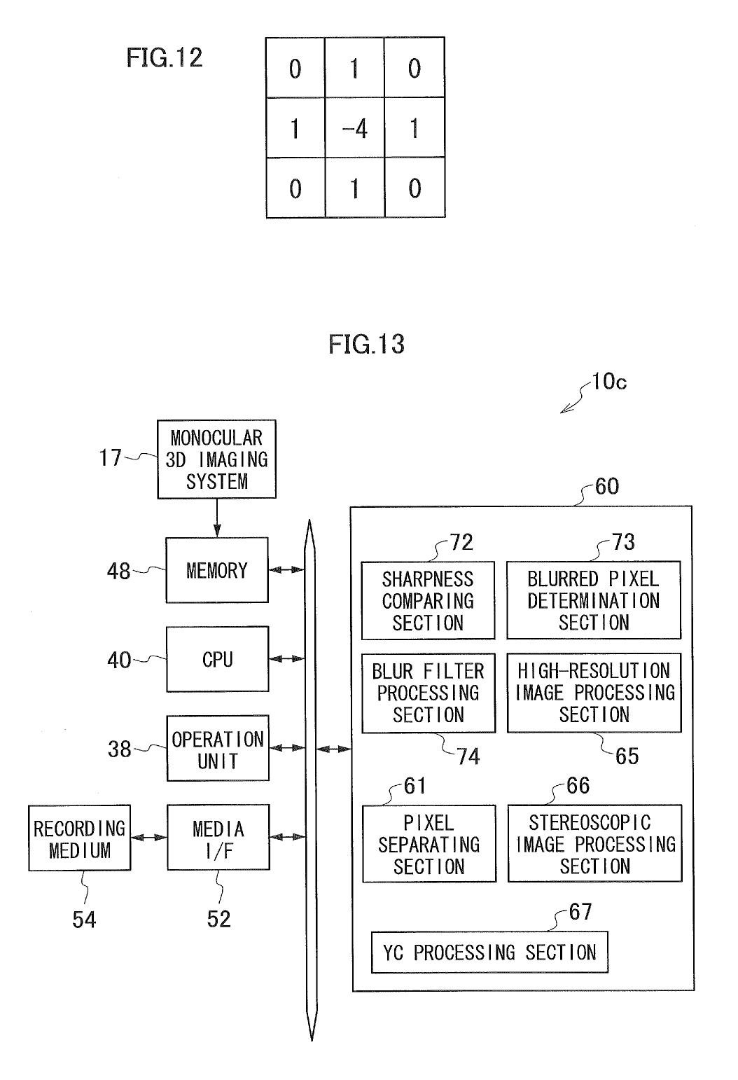

The calculation of the sharpness of each pixel is made with a Laplacian filter processing. FIG. 12 illustrates an example of filter geometry of the Laplacian filter. Edge is detected by the Laplacian filter processing; and the absolute value of an output value represents the sharpness. A pixel with the smaller blur amount has the larger sharpness; and a pixel with the larger blur amount has the smaller sharpness. The Laplacian filter is not limited to the second embodiment. The sharpness may be calculated by using a filter other than the Laplacian filter.

In step S25, the blurred pixel determination section 73 determines if the absolute value of the sharpness difference |k| is larger than a threshold value kₜₕ. When the |k| is larger than the threshold value kₜₕ, since the difference of the blur amount between the pixels in the pair is large, there is a possibility that noise may be generated due to the parallax amount.

In step S26, the blur average processing section 64 performs the averaging of the pixel value between the pixels in a pair which has the absolute value of the sharpness difference |k| larger than the threshold value kₜₕ. In step S27, it is determined if all pixels have been selected. If not, the process returns to step S23; if yes, the process proceeds to step S28.

Steps S28 and S29 are the same as step S8 and S9 in the first embodiment shown in FIG. 7.

According to the second embodiment, only the portion that has a large difference of blur amount in all areas of a high resolution planar image is limited as a target area of the averaging. Therefore, noises are reduced without reducing the resolution of the focused main object.

### Third Embodiment

Subsequently, a third embodiment will be described. According to the third embodiment, in place of the averaging, a filter processing is applied to reduce noises caused from the parallax by reducing the sharpness of a pixel only that has a smaller blur amount in a pixel pair. That is, the processing is made only on a pixel that has smaller blur amount to further reduce the blur.

FIG. 13 is a block diagram showing a configuration of an essential part of an imaging device according to the third embodiment. The same components as those in the imaging device according to the second embodiment shown in FIG. 10 are given with the same reference numeral and character respectively, and as for the items which have been described above, description thereof is omitted here.

The blurred pixel determination section 73 according to the third embodiment compares an absolute value of a sharpness difference (difference of blur amount) calculated by the sharpness comparing section 72 to a threshold value. When the absolute value of the sharpness difference is larger than a threshold value, the blurred pixel determination section 73 determines the blur amount of which pixel is larger in two pixels (pixel pair) of the left image and the right image each corresponding to two imaging pixels, which are disposed adjacent to each other in the image pickup device 16, based on the symbol (plus or minus) attached to the sharpness difference.

A blur filter processing section 74 performs a filter processing on a pixel pair which has the absolute value of the sharpness difference (difference of blur amount) larger than threshold value to blur the pixel only that has a smaller blur amount in the pixel pair. On the other hand, the blur filter processing section 74 does not perform the filter processing on a pixel pair which has the absolute value of the sharpness difference smaller than the threshold value.

As the filter, for example, a Gaussian filter is used. Gaussian filter coefficient f(x) is shown in Formula 1.

$$f ( x ) = \frac{1}{\sqrt{2 {πσ}^{2}}} exp ( - \frac{{x}^{2}}{2 {σ}^{2}} ) \qquad \{ Formula 1 \}$$

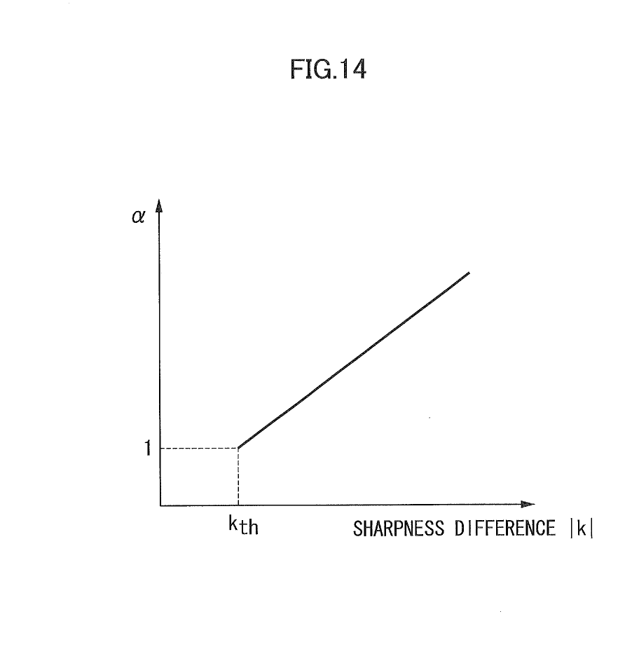

FIG. 14 is a graph showing a relationship between the sharpness difference |k| and a parameter α of the Gaussian filter. When |k| is larger than a threshold value kₜₕ, α which has a proportional relationship with |k|, and the Gaussian filter coefficient f(x) corresponding to α is determined. To calculate the f(x) from α, a calculation is made using Formula 1, and normalization is made so that the summation of the calculated f(x) is “1”.

In the case of a digital filter, f(x) is determined for each discrete position around a target pixel. For example, in the case of five-tap filter; f(x)=[0.1, 0.2, 0.4, 0.2, 0.1]. Generally, to prevent the brightness of image from changing, normalization is made so that the summation of coefficients is “1.0.” Although one-dimension filter coefficient is shown here, two-dimension filter processing may made by performing the filter processing in a horizontal direction and a vertical direction. A filter other than Gaussian filter (for example, low pass filter) may be used.

The blur filter processing section 74 preferably determines the filter coefficient based on at least one of the difference of blur amount (in this embodiment, the sharpness difference), the focal point distance at imaging and the aperture value at imaging.

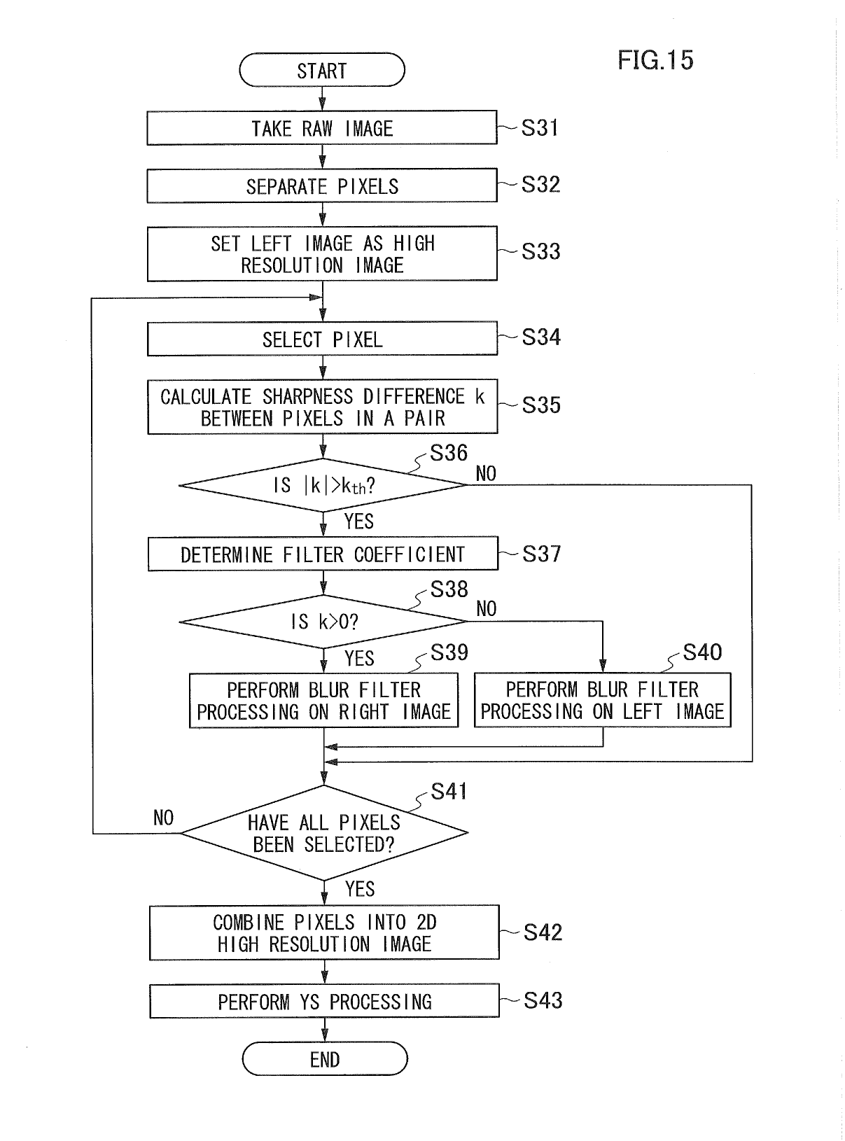

FIG. 15 is a flowchart showing a flow of the image processing according to the third embodiment.

Steps S31 and S32 are the same as steps S1 and S2 respectively in the first embodiment shown in FIG. 7.

In step S33, the left image is set as the reference image.

In step S34, the target pixel is selected from the reference images.

In step S35, the sharpness comparing section 72 calculates the sharpness difference between the pixel of the left image 80L and the pixel of the right image 80R each corresponding to the main pixel PDa and the sub pixel PDb which are disposed in a pair on the image pickup device 16. (Sharpness difference)=(sharpness of the pixel on the right image 80R)−(sharpness of the pixel on the left image 80L).

In step S36, the blurred pixel determination section 73 determines if the absolute value of the sharpness difference |k| is larger than the threshold value kₜₕ. If the |k| is larger than the threshold value kₜₕ, since the difference of blur amount between the pixels in the pair is large, there is a possibility that noises are generated caused from the parallax amount.

In step S37, the filter coefficient is determined.

In step S38, it is determined if the sharpness difference k is a plus value or not. When the sharpness difference k is a plus value, the filter processing is made on the pixel of the right image in step S39. On the other hand, when the sharpness difference k is not a plus vale, the filter processing is made on the pixel of the left image in step S40. That is, the difference of blur amount is controlled by applying the filter processing on the pixel which has a higher sharpness to reduce the sharpness.

In step S40, it is determined if all pixels have been selected. If not, the process returns to step S34; and if yes, the process proceeds to step S41.

Steps S42 and S43 are the same as steps S8 and S9 according to the first embodiment shown in FIG. 7.

According to the third embodiment, the sharpness comparing section 72 calculates the difference of blur amount between the common portions in an imaging pixel geometry on the image pickup device, which is the difference of blur amount between each portion of the left image and each portion of the right image. And the blur filter processing section 74 performs the blur processing on the portion which has the absolute value of the difference of blur amount larger than threshold value in the left image and the right image. Therefore, the blur amount is prevented from expanding to the minimum while reliably eliminating the noise pattern caused from the parallax.

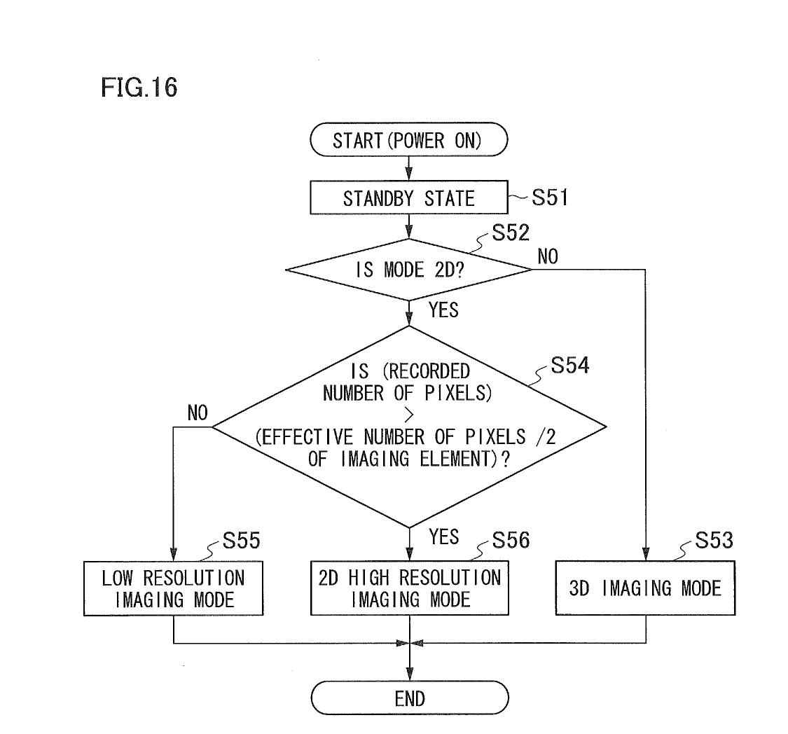

FIG. 16 is a flowchart showing a flow of an imaging mode selection processing in the imaging device 10 in FIG. 1. The processing is executed by the CPU 40 in FIG. 1. This processing may be made in any embodiments from the first embodiment to the third embodiment.

When the power is turned on, the imaging device 10 gets into a standby state (step S51). In the standby state, an instruction operation is received to select the imaging mode through the operation unit 38.

Receiving the selection instruction operation, it is determined that the imaging mode instructed to select is the 2D imaging mode or the 3D imaging mode (step S52).

When the 3D imaging mode is instructed to select, the 3D imaging mode is set (step S53).

When the 2D imaging mode is instructed to select, it is determined if the recorded number of pixels is larger than (effective number of pixels/2 of image pickup device 16) (step S54). When the recorded number of pixels is larger than the (effective number of pixels/2 of image pickup device 16), a 2D high resolution imaging mode is set (step S55). On the other hand, when the recorded number of pixels is smaller than the (effective number of pixels/2 of image pickup device 16), a 2D low resolution imaging mode is set (step S56). In the 2D low resolution imaging mode, the resolution of a 2D-image to be recorded is set, for example, to 1/2 of the 2D high resolution imaging mode.

In the 3D imaging mode, an ordinary Bayer processing is made on each of the left image and the right image.

In the processing in 2D low resolution imaging mode, the averaging processing is made on all pixels to prevent the generation of pattern noises caused from the parallax.

According to the third embodiment, the 2D high resolution imaging mode (high resolution planar image imaging mode) for generating a high resolution planar image, the 2D low resolution imaging mode (low resolution planar image imaging mode) for generating a 2D low-resolution image, the resolution of which is lower than that of the high resolution planar image, and the 3D imaging mode (stereoscopic image imaging mode) for generating a 3D-image (stereoscopic image) are available. When the 2D high resolution imaging mode is set, a high resolution planar image is generated.

The present invention is not particularly limited to the case shown in FIG. 16. For example, the 2D-image imaging mode for generating a high resolution planar image, and the 3D imaging mode for generating a 3D-image are available, and when the 2D-image imaging mode is set, a high resolution planar image may be generated.

According to the present invention, the method of pupil division is not particularly limited to a mode in which the light shielding member 16A for pupil division, which is shown in FIG. 3, FIG. 4A and FIG. 4B, is used. For example, in the microlens L and the photodiode PD mode in which pupil division is made depending on the geometry or shape of at least either one; or a mode in which the pupil division is made by a mechanical diaphragm 14, or other mode may be employed.

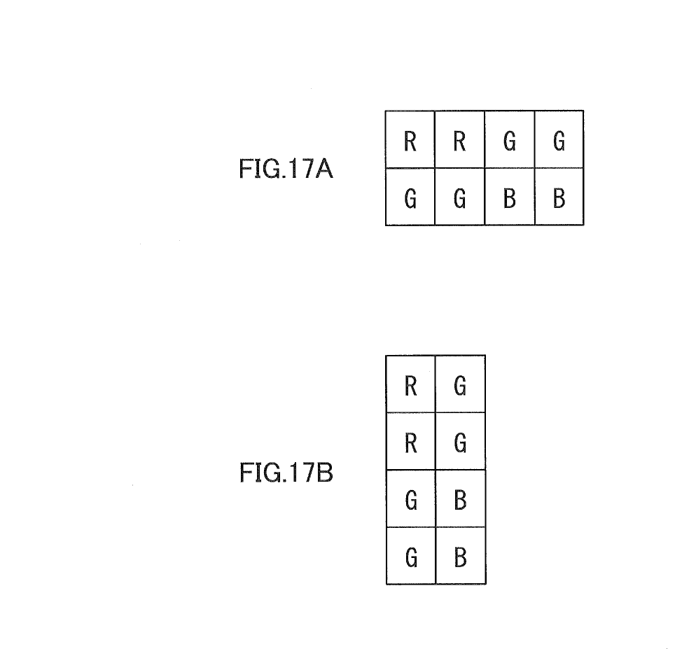

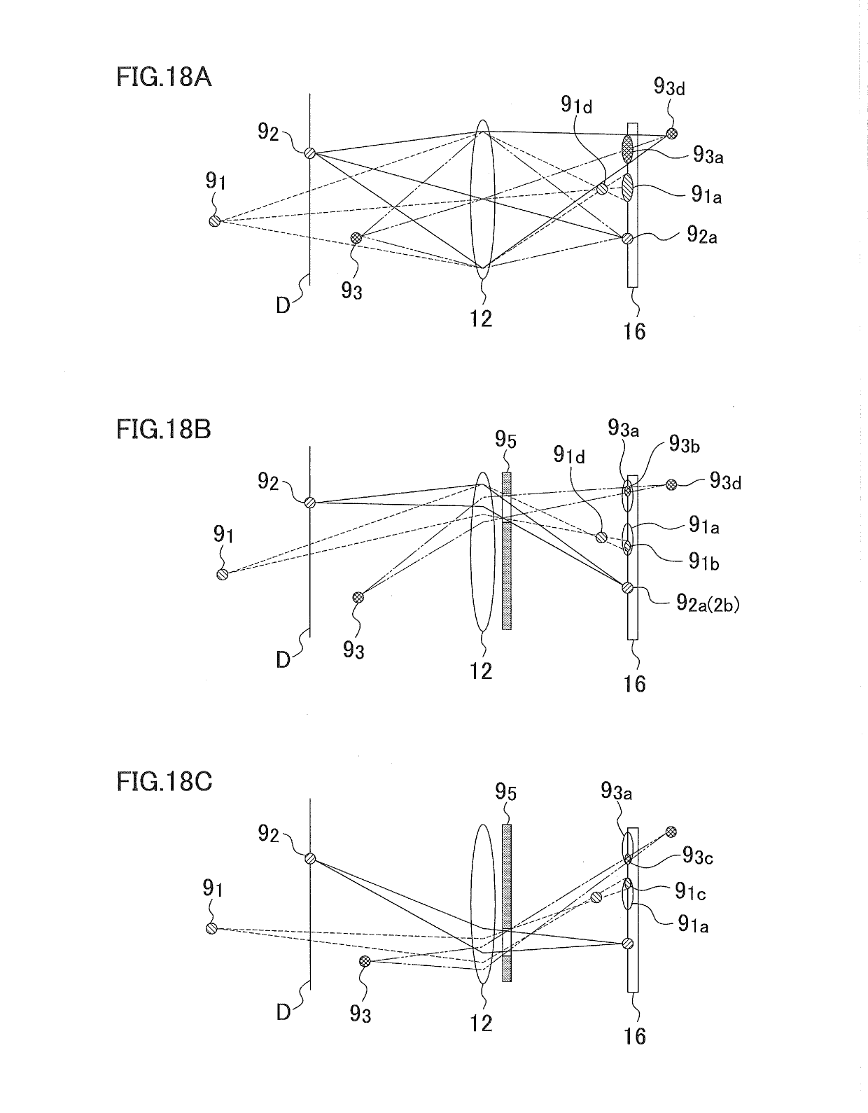

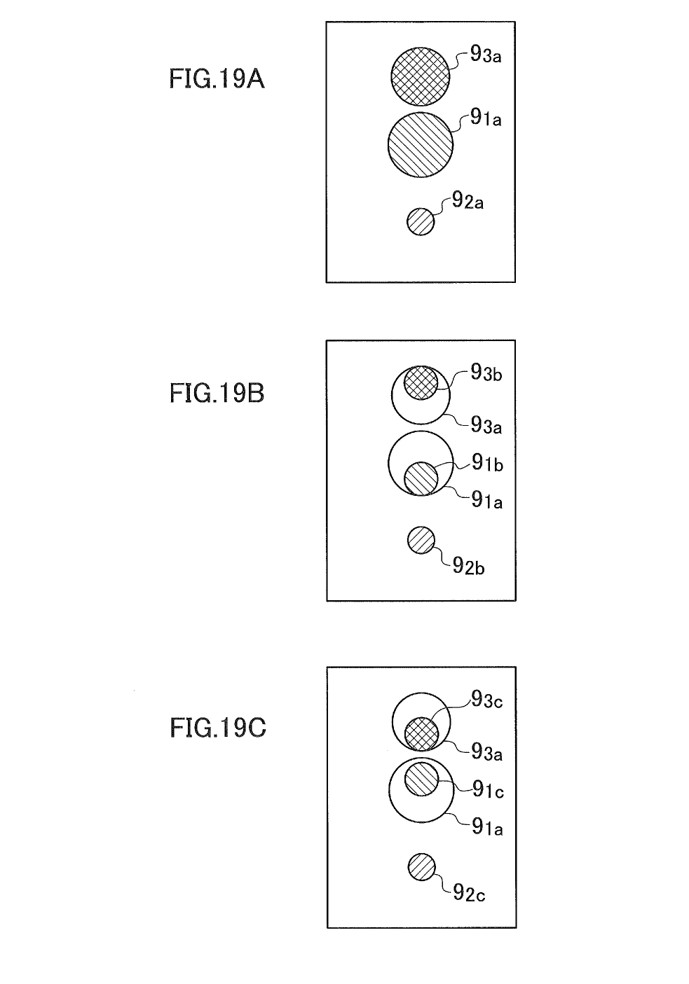

When the geometry of the imaging pixels is the honeycomb geometry shown in FIG. 2, the geometry in the image pickup device 16 is not limited. A Bayer array, a part of which is schematically shown in FIG. 17A and FIG. 17B, may be employed. In particular, a double Bayer array is employed, in which both of the pixel geometry of the entire even rows (main pixel geometry) and the pixel geometry of the entire odd rows (sub pixel geometry) are the Bayer array. In FIG. 17A and FIG. 17B, R, G and B represent an imaging pixel each having a filter of red, green or blue. Each pixel pair includes two pixels of R-R, G-G, and B-B adjacent to each other (i.e. same color neighboring pixels). A pixel of the left image is formed with one pixel signal in the pixel pair, and a pixel of the right image is formed with other pixel signal in the pixel pair.

The image pickup device 16 is not particularly limited to a CCD image pickup device. For example, a CMOS (complementary metal-oxide semiconductor) image pickup device may be used.

According to the first embodiment to the third embodiment, the threshold value used for determination is calculated by the CPU 40 based on a calculation condition such as, for example, a monitor size (size of the display screen), a monitor resolution (resolution of the display screen), viewing distance (distance viewing the display screen) or stereoscopic fusion limit of a user (varies among different individuals). The calculation condition may be set manually by a user or automatically. When the setting is made by the user, the setting operation is made through the operation unit 38 and the setting is stored in the EEPROM 56. A piece of information on the size and the resolution of the monitor (resolution of the display monitor) may be obtained automatically from the monitor (LCD 30 in FIG. 1) or the like. As for calculation conditions which are not set by the user (or calculation conditions which are not obtained automatically), standard conditions may be applied.

The present invention is not limited to the examples described in this description or the examples illustrated in the figures. Needles to say, various design changes and/or modifications are possible within a range of the sprit of the present invention.

### REFERENCE SIGNS LIST

10 (10a, 10b, 10c) . . . imaging device, 12 . . . image taking lens, 16 . . . image pickup device, 40 . . . CPU, 60 . . . DSP, 62 . . . parallax map generating section, 63, 73 . . . blurred pixel determination section, 64 . . . blur average processing section, 65 . . .l high resolution processing section, 66 . . . stereoscopic image processing section, 72 . . . sharpness comparing section, 74 . . . blur filter processing section, 80 . . . RAW image, 80L . . . left image (first planar image), 80R . . . right image(second planar image), 88 . . . parallax map

1. An imaging device, comprising:
a single imaging optical system;
an image pickup device that has a first imaging pixel group and a second imaging pixel group each of which performs a photoelectric conversion on a luminous flux which has passed through a different area in the single imaging optical system;
a stereoscopic image generating device configured to generate a stereoscopic image including a first planar image based on a pixel signal from the first imaging pixel group and a second planar image based on a pixel signal from the second imaging pixel group;
a parallax amount calculating device configured to calculate a parallax amount in each part of the first planar image and the second planar image;
a determination device configured to determine that a portion which has the parallax amount larger than a threshold value in the first planar image and the second planar image is a blurred portion;
a blur processing device configured to perform blur processing on the blurred portion in the first planar image and the second planar image; and
a high resolution planar image generating device configured to generate a high resolution planar image by combining the first planar image and the second planar image with each other after the blur processing.

2. The imaging device according to claim 1, wherein the blur processing is averaging or filter processing of a pixel value in a portion having the parallax amount larger than a threshold value.

3. The imaging device according to claim 1, wherein
the parallax amount calculating device calculates the parallax amount in each of the pixels of the first planar image and the second planar image,
the determination device determines that a pixel which has the parallax amount larger than the threshold value is a blurred pixel, and
the blur processing device picks up a pixel pair including a pixel in the first planar image and a pixel in the second planar image, each pixel pair corresponding to the first imaging pixel and the second imaging pixel which are disposed adjacent to each other in the image pickup device as a target, and performs the averaging of the pixel value between the pixels in the pixel pair including the blurred pixel.

4. An imaging device, comprising:
a single imaging optical system;
an image pickup device that has a first imaging pixel group and a second imaging pixel group each of which performs a photoelectric conversion on a luminous flux which has passed through a different area in the single imaging optical system;
a stereoscopic image generating device configured to generate a stereoscopic image including a first planar image based on a pixel signal from the first imaging pixel group and a second planar image based on a pixel signal from the second imaging pixel group;
a blur amount difference calculating device configured to calculate a difference of a blur amount between common portions in an imaging pixel geometry of the image pickup device, which is a difference of blur amount between each portion of the first planar image and each portion of the second planar image;
a blur processing device configured to perform blur processing on a portion having an absolute value of the difference of blur amount larger than a threshold value in the first planar image and the second planar image; and
a high resolution planar image generating device configured to generate a high resolution planar image by combining the first planar image and the second planar image with each other after the blur processing.

5. The imaging device according to claim 4, wherein the blur amount difference calculating device calculates a difference of sharpness between the pixels included in the pixel pair as the difference of blur amount.

6. The imaging device according to claim 4, wherein the blur processing is averaging or filter processing of a pixel value in the portion with the absolute value of the difference of blur amount larger than the threshold value.

7. The imaging device according to claim 4, wherein the blur amount difference calculating device takes, as a target, each pixel pair corresponding to the first imaging pixel and the second imaging pixel disposed adjacent to each other in the image pickup device, which is a pixel pair of a pixel of the first planar image and a pixel of the second planar image, and calculates the difference of blur amount between the pixels included in the pixel pair, and
the blur processing device performs the averaging of the pixel value between the pixels in the pixel pair which has the absolute value of the difference of blur amount larger than the threshold value.

8. The imaging device according to claim 4, wherein the blur amount difference calculating device takes, as a target, each pixel pair corresponding to the first imaging pixel and the second imaging pixel disposed adjacent to each other in the image pickup device, which is a pixel pair of a pixel of the first planar image and a pixel of the second planar image, and calculates the difference of blur amount between the pixels included in the pixel pair, and
the blur processing device performs the filter processing on only the pixel with a smaller blur amount in the pixel pair which has the absolute value of the difference of blur amount larger than threshold value.

9. The imaging device according to claim 8, wherein the blur processing device determines a filter coefficient based on at least the difference of blur amount.

10. The imaging device according to claim 1, wherein the imaging device has a high resolution planar image imaging mode for generating the high resolution planar image, a low resolution planar image imaging mode for generating a low resolution planar image having the resolution lower than that of the high resolution planar image and a stereoscopic image imaging mode for generating the stereoscopic image, and
when the high resolution planar image imaging mode is set, the high resolution planar image is generated.

11. The imaging device according to claim 1, wherein the imaging device has a planar image imaging mode for generating the high resolution planar image and a stereoscopic image imaging mode for generating the stereoscopic image, and
when the planar image imaging mode is set, the high resolution planar image is generated.

12. The imaging device according to claim 1, wherein the pixel geometry of the image pickup device is a honeycomb arrangement.

13. The imaging device according to claim 1, wherein the pixel geometry of the image pickup device is a Bayer arrangement.

14. An image processing device, comprising:
a parallax amount calculating device configured to calculate a parallax amount of each portion of a first planar image based on a pixel signal from the first imaging pixel group and a second planar image based on a pixel signal of the second imaging pixel group, which is obtained by taking an image of an object using an image pickup device including a first imaging pixel group and a second imaging pixel group each of which performs a photoelectric conversion on a luminous flux which has passed through a different area of a single imaging optical system;
a determination device configured to determine that a portion which has the parallax amount larger than a threshold value in the first planar image and the second planar image is a blurred portion;
a blur processing device configured to perform blur processing on the blurred portion in the first planar image and the second planar image; and
a high resolution planar image generating device configured to generate a high resolution planar image by combining the first planar image and the second planar image with each other after the blur processing.

15. An image processing device, comprising:
a blur amount difference calculating device configured to calculate a difference of blur amount between common portions in imaging pixel geometry of an image pickup device, which is the difference of blur amount between respective portions of a first planar image based on a pixel signal of the first imaging pixel group and a second planar image based on a pixel signal of the second imaging pixel group and which is obtained by taking an image of an object using an image pickup device including a first imaging pixel group and a second imaging pixel group each of which performs a photoelectric conversion on a luminous flux which has passed through different areas of a single imaging optical system;
a blur processing device configured to perform blur processing on a portion which has an absolute value of the difference of blur amount larger than a threshold value in the first planar image and the second planar image; and
a high resolution planar image generating device configured to generate a high resolution planar image by combining the first planar image and the second planar image with each other after the blur processing.

16. An image processing method, comprising:
a step of generating, when an image of an object is taken using an image pickup device which has a first imaging pixel group and a second imaging pixel group each of which performs a photoelectric conversion on a luminous flux which has passed through different areas of a single imaging optical system, a high resolution planar image from a first planar image based on a pixel signal of the first imaging pixel group and a second planar image based on a pixel signal of the second imaging pixel group;
a step of calculating a parallax amount of each portion of the first planar image and the second planar image;
a step of determining that a portion which has the parallax amount larger than a threshold value in the first planar image and the second planar image is a blurred portion;
a blur processing step of performing blur processing on the blurred portion in the first planar image and the second planar image; and
a step of generating a high resolution planar image by combining the first planar image and the second planar image after the blur processing.

17. An image processing method, comprising:
a step of generating, when an image of an object is taken using an image pickup device which has a first imaging pixel group and a second imaging pixel group each of which performs a photoelectric conversion on a luminous flux which has passed through different areas of a single imaging optical system, a high resolution planar image from a first planar image based on a pixel signal of the first imaging pixel group and a second planar image based on a pixel signal of the second imaging pixel group;
a blur amount difference calculation step of calculating a difference of blur amount between common portions in an imaging pixel geometry of the image pickup device, which is a difference of blur amount between each portion of the first planar image and each portion of the second planar image;
a blur processing step of performing blur processing on a portion which has an absolute value of the difference of blur amount larger than a threshold value in the first planar image and the second planar image; and
a step of generating a high resolution planar image by combining the first planar image and the second planar image after the blur processing.
